(19) United States
(12) Patent Application Publication
(10) Pub. No.: US 2022/0259900 A1
(43) Pub. Date: Aug. 18, 2022

(54) VEHICLE DOOR LOCK DEVICE

(71) Applicants: AISIN CORPORATION, Kariya (JP); TOYOTA JIDOSHA KABUSHIKI KAISHA, Toyota-shi (JP)

(72) Inventors: Takashi OKADA, Kariya-shi (JP); Kota KATAHARA, Kariya-shi (JP); Ryu MIYASHIRO, Kariya-shi (JP); Tetsuya SUEMATSU, Miyoshi-shi (JP); Satoshi TAKATO, Nagoya-shi (JP)

(73) Assignees: AISIN CORPORATION, Kariya (JP); TOYOTA JIDOSHA KABUSHIKI KAISHA, Toyota-shi (JP)

(21) Appl. No.: 17/649,966

(22) Filed: Feb. 4, 2022

(30) Foreign Application Priority Data
Feb. 12, 2021 (JP) 2021-020752

(51) Int. Cl. E05B 81/56; E05B 81/06; E05B 81/64

(52) U.S. Cl. CPC E05B 81/56; E05B 81/64; E05B 81/06

(57) ABSTRACT

A vehicle door lock device includes: a first member moving from an initial position to an actuated position so as to switch a latch mechanism, from a latched state to an unlatched state; a second member moving between a mechanical link position and a mechanical link cut position; a third member linked to the second member and holding the second member at the mechanical link cut position and holding the second member at the mechanical link position; a driving force source selectively moving the third member to one of the first and second positions; an operating member moving from an initial position to an actuated position, and moving the third member from the first position to the second position; and a control unit driving the driving force source. The control unit drives the driving force source to move the third member from the first position to the second position.

### CROSS REFERENCE TO RELATED APPLICATIONS

This application is based on and claims priority under 35 U.S.C. § 119 to Japanese Patent Application 2021-020752, filed on Feb. 12, 2021, the entire content of which is incorporated herein by reference.

### TECHNICAL FIELD

The disclosure relates to a vehicle door lock device.

### BACKGROUND DISCUSSION

JP 2019-31858A (Reference 1) discloses a vehicle door opening/closing control device configured to, by a control device operating a motor or the like according to an operation of a user, switch a door lock device to a mechanical link cut state (a state where a vehicle door cannot be opened by a manual operation, also referred to as a locked state), a mechanical link state (a state where the vehicle door can be opened by a manual operation, also referred to as an unlocked state), or an unlatched state (a state where the vehicle door can be opened). The door lock device disclosed in Reference 1 includes an automatic switching mechanism capable of switching the door lock device to the mechanical link cut state, the mechanical link state, and a “state where a latch mechanism is in the unlatched state” by a driving force of a driving force source.

There is a request on the door lock device that the door lock device can also be switched from the mechanical link cut state to the mechanical link state by a manual operation. Therefore, the door lock device includes a manual switching mechanism for switching the door lock device from the mechanical link cut state to the mechanical link state by a manual operation. Accordingly, the door lock device may include both the automatic switching mechanism and the manual switching mechanism described above.

In a case where the user manually operates the manual switching mechanism to switch the state of the door lock device, when the manual operation is insufficient or incomplete, the state of the door lock device may not be switched. Further, in a case where the state of the door lock device is not actually switched even though the user manually operates the door lock device, when the driving force source is operated thereafter, the door lock device may be switched to a state not intended by the user. In addition, while the user manually is operating the manual switching mechanism, the door lock device is in an intermediate state, which is not any of the three states. When the driving force source is operated in such an intermediate state, the door lock device may be switched to a state not intended by the user. However, Reference 1 does not disclose a configuration for reliably switching the state of the door lock device by a manual operation.

A need thus exists for a door lock device which is not susceptible to the drawback mentioned above.

### SUMMARY

A vehicle door lock device (20) according to the disclosure includes: a first member (52) configured to move from an initial position to an actuated position so as to switch a latch mechanism (50), which is configured to be switched between a latched state where a vehicle door (12) is able to be held in a closed state and an unlatched state where the closed state of the vehicle door is able to be released, from the latched state to the unlatched state; a second member (30) configured to move between a mechanical link position where the second member (30) is engaged with the first member (52) so as to be able to switch the latch mechanism (50) from the latched state to the unlatched state and a mechanical link cut position where the second member (30) is not engaged with the first member (52) so as not to be able to switch the latch mechanism (50) from the latched state to the unlatched state; a third member (25) linked to the second member (30) and configured to hold the second member (30) at the mechanical link cut position by being located at a first position (a mechanical link cut position), and to hold the second member (30) at the mechanical link position by being located at a second position (a mechanical link position); a driving force source (22) configured to selectively move, by a driving force thereof, the third member (25) to either the first position (the mechanical link cut position) or the second position (the mechanical link position); an operating member (131) configured to move from an initial position to an actuated position by a manual operation of a user, and configured to, when moving from the initial position to the actuated position in a state where the third member (25) is located at the first position (the mechanical link cut position), move the third member (25) from the first position (the mechanical link cut position) to the second position (the mechanical link position); and a control unit (601) configured to drive the driving force source.

The control unit (601) is configured to, when the operating member (131) moves from the initial position to the actuated position in a state where the third member (25) is located at the first position (the mechanical link cut position), drive the driving force source (22) to move the third member (25) from the first position (the mechanical link cut position) to the second position (the mechanical link position).

Further, a vehicle door lock device (20) according to the disclosure includes: a first member (52) configured to move from an initial position to an actuated position so as to switch a latch mechanism (50), which is configured to be switched between a latched state where a vehicle door (12) is able to be held in a closed state and an unlatched state where the closed state of the vehicle door is able to be released, from the latched state to the unlatched state; a second member (30) configured to move between a mechanical link position where the second member (30) is engaged with the first member (52) so as to be able to switch the latch mechanism (50) from the latched state to the unlatched state and a mechanical link cut position where the second member (30) is not engaged with the first member (52) so as not to be able to switch the latch mechanism (50) from the latched state to the unlatched state; a third member (25) linked to the second member (30) and configured to hold the second member (30) at the mechanical link cut position by being located at a first position (a mechanical link cut position), and to hold the second member (30) at the mechanical link position by being located at a second position (a mechanical link position); a driving force source (22) configured to selectively move, by a driving force thereof, the third member (25) to either the first position (the mechanical link cut position) or the second position (the mechanical link position); a key cylinder (142) configured to allow a rotation operation by inserting a key from a vehicle outer side, and configured to move the third member (an active lever) located at the second position (the mechanical link position) to the first position (the mechanical link cut position) by the rotation operation in a predetermined direction and move the third member (the active lever) located at the first position (the mechanical link cut position) to the second position (the mechanical link position) by the rotation operation in a direction opposite to the predetermined direction; and a control unit (601) configured to drive the driving force source (22).

The control unit (601) is configured to: determine, when the third member (25) is located at the second position (the mechanical link position), whether a relock condition, which is a condition for moving the third member (25) from the second position to the first position (the mechanical link cut position), is satisfied and whether the key cylinder (142) is being operated, when it is determined that the relock condition is satisfied and that the key cylinder (142) is not being operated, drive the driving force source (22) to move the third member (25) to the first position (the mechanical link cut position), and when it is determined that the relock condition is satisfied and that the key cylinder (142) is being operated, not drive the driving force source (22).

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic diagram showing a configuration example of a vehicle door;

FIG. 2 is a cross-sectional view taken along line II-II in FIG. 1;

FIG. 3 is an exploded perspective view showing a configuration of a door lock device;

FIG. 4 is a diagram showing a mechanical link cut state of the door lock device;

FIG. 5 is a diagram showing a mechanical link state of the door lock device;

FIG. 6 is a diagram showing an operation of switching the door lock device to an unlatched state;

FIG. 7 is a diagram showing an operation of switching the door lock device from the mechanical link state to the mechanical link cut state;

FIG. 8 is a diagram showing an operation of switching the door lock device from the mechanical link state to the mechanical link cut state;

FIG. 9 is a diagram showing a control system of the door lock device;

FIG. 10 is a diagram showing a transition of the state of the door lock device;

FIG. 11 is a diagram showing an operation of switching the door lock device from the mechanical link state to the mechanical link cut state;

FIG. 12 is a flowchart showing a routine executed by a CPU; and

FIG. 13 is a flowchart showing a routine executed by the CPU.

### DETAILED DESCRIPTION

### (Vehicle Door)

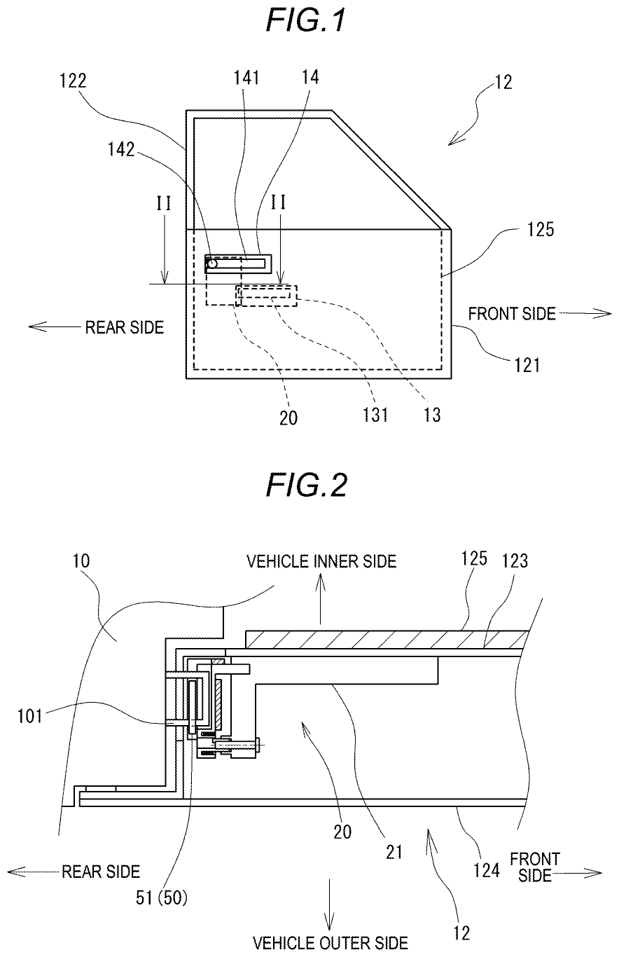

FIG. 1 is a side view of a vehicle door 12 to which a door lock device 20 is applied, and is a view seen from a vehicle outer side. FIG. 2 is a cross-sectional view of a vicinity of a rear end of the vehicle door 12 to which the door lock device 20 is applied, and is a cross-sectional view taken along line II-II in FIG. 1.

The vehicle door 12 is rotatably connected to a vehicle body 10, and can be closed and opened by being rotationally moved with respect to the vehicle body 10. The vehicle door 12 includes a door main body 121 constituting a lower half of the vehicle door 12, and a door sash 122 provided in an upper half of the vehicle door 12. The door main body 121 includes an inner panel 123, an outer panel 124, and a trim 125. The outer panel 124 constitutes an outer side surface of the vehicle door 12. The inner panel 123 is fixed to a vehicle inner side of the outer panel 124. The trim 125 is fixed to a vehicle inner side of the inner panel 123 and constitutes an inner side surface of the door main body 121.

An outside door handle device 14 is attached to the outer panel 124. The outside door handle device 14 includes an outside door handle 141 that is rotatable with respect to the vehicle body 10, and a key cylinder 142 into which a key can be inserted and rotated. The key cylinder 142 is always biased to a neutral position by a biasing member (not shown), and when the key cylinder 142 is located at the neutral position, the key can be inserted into and removed from the key cylinder 142. A user can rotate the key cylinder 142 to both directions from the neutral position by inserting the key into the key cylinder 142. An inside door handle device 13 is attached to the trim 125. The inside door handle device 13 includes an inside door handle 131 that is rotationally movable with respect to the vehicle door 12. Both of the outside door handle 141 and the inside door handle 131 are elastically biased toward an initial position by a biasing member (not shown), and are held at the initial position while not being operated. The user of the vehicle can move the outside door handle 141 or the inside door handle 131 from the initial position to an actuated position by rotating the outside door handle 141 or the inside door handle 131 against a biasing force of the biasing member. The actuated position of the inside door handle 131 or the outside door handle 141 is a position obtained by rotating the initial position by a predetermined angle.

### (Outline of Door Lock Device)

As shown in FIG. 2, the door lock device 20 is disposed in an internal space of the vehicle door 12 (that is, a space surrounded by the inner panel 123 and the outer panel 124). A part of the door lock device 20 is exposed to the outside at the rear end of the vehicle door 12. The door lock device 20 is fixed to the inner panel 123 (that is, the vehicle door 12).

The door lock device 20 includes a housing 21, which is a casing, a latch mechanism 50, a manual switching mechanism, and an automatic switching mechanism. The latch mechanism 50 can be switched between a latched state where the vehicle door 12 can be held in a closed state and an unlatched state where the closed state of the vehicle door 12 can be released. Further, the door lock device 20 can be switched among a mechanical link state, a mechanical link cut state, and a “state where the latch mechanism 50 is in the unlatched state”. The mechanical link state is a state where the latch mechanism 50 is allowed to be switched from the latched state to the unlatched state by a predetermined manual operation on the inside door handle 131 and the outside door handle 141. The mechanical link cut state is a state where the latch mechanism 50 cannot be switched from the latched state to the unlatched state by a predetermined manual operation on the inside door handle 131 and the outside door handle 141.

The manual switching mechanism can switch the door lock device 20 from the mechanical link state to the “state where the latch mechanism 50 is in the unlatched state” (in other words, can switch the latch mechanism 50 from the latched state to the unlatched state) by a predetermined manual operation on the inside door handle 131 and the outside door handle 141 (specifically, an operation of moving the inside door handle 131 and the outside door handle 141 from the initial position to the actuated position once, also referred to as a “door opening operation”). Further, the manual switching mechanism can switch the door lock device 20 from the mechanical link cut state to the mechanical link state by a predetermined manual operation on the inside door handle 131.

The automatic switching mechanism can switch, by a driving force of a motor 22 to be described later, the door lock device 20 to any of the mechanical link state, the mechanical link cut state, and the “state where the latch mechanism 50 is in the unlatched state”. Further, the automatic switching mechanism can switch, by a manual operation on the key cylinder 142, the door lock device 20 from the mechanical link cut state to the mechanical link state and switch the door lock device 20 from the mechanical link state to the mechanical link cut state.

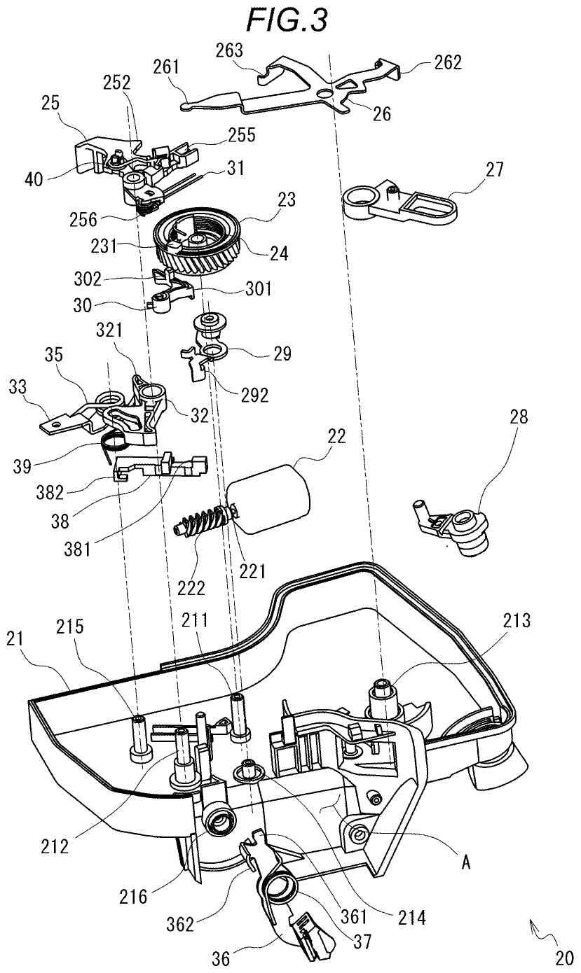

FIG. 3 is an exploded perspective view showing a mechanical configuration of the door lock device 20. The door lock device 20 includes the housing 21, the motor 22, a rotating member 23, a rotating member biasing member 24, an active lever 25, a detent spring 40, a control lever 26, an outside locking lever 28, a key switch lever 27, a blocking lever 38, a blocking lever biasing member 39, a release lever 29, an inside lever 32, an inside open lever 33, an outside open lever 36, an outside open lever biasing member 37, an open link 30, and the latch mechanism 50.

The housing 21 is a casing of the door lock device 20. The housing 21 includes a first support portion 211, a second support portion 212, a third support portion 213, a fourth support portion 214, a fifth support portion 215, and a sixth support portion 216. The first support portion 211 is a portion that rotatably supports the rotating member 23. The second support portion 212 is a portion that coaxially rotatably supports the active lever 25 and the inside lever 32. The third support portion 213 is a portion that rotatably supports the control lever 26. The fourth support portion 214 is a portion that rotatably supports the release lever 29. The fifth support portion 215 is a portion that rotatably supports the inside open lever 33. The sixth support portion 216 is a portion that rotatably supports the outside open lever 36. The support portions are cylindrical protrusions integrally formed with the housing 21.

A shaft hole is formed in each of the rotating member 23, the active lever 25, the control lever 26, the release lever 29, the inside lever 32, the inside open lever 33, and the outside open lever 36. Then, by inserting the first support portion 211 to the sixth support portion 216 into the respective shaft holes of the members, the members are supported on the housing 21 rotatably around the support portions, respectively. The open link 30 is rotatably supported by the outside open lever 36.

### (Latch Mechanism)

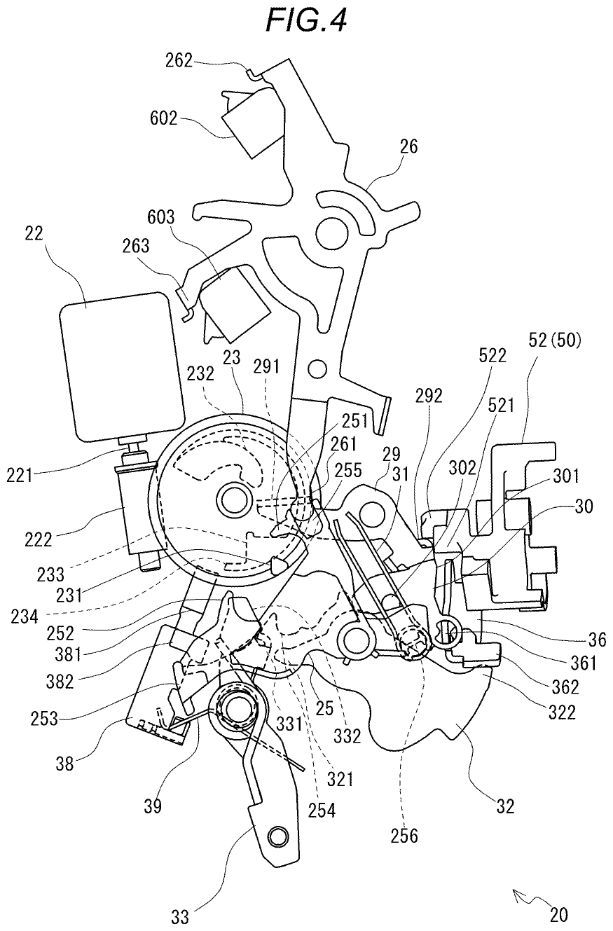

The latch mechanism 50 is disposed in a region A of the housing 21 in FIG. 3. The latch mechanism 50 includes a latch 51 (see FIG. 2), a pawl (not shown), and a lift lever 52 (see FIGS. 4 to 8 and FIG. 11). The latch 51 is rotatably supported by a frame of the door lock device 20 (the frame is a member attached to the housing 21) or the like, and is movable, due to rotation thereof, between an unlatched position and a latched position (the latched position includes a half latched position and a fully latched position). The unlatched position is a position where a striker 101 provided on the vehicle body 10 is not held (in other words, a position where the striker 101 can be engaged), that is, a position where meshing between the latch 51 and the striker 101 can be released. The latched position is a position where, when the vehicle door 12 is in the closed state, the striker 101 provided on the vehicle body 10 is held (in other words, a position where the striker 101 is engaged), that is, a position where the meshing between the latch 51 and the striker 101 cannot be released. The latch 51 is always biased toward the unlatched position by a latch return spring.

The pawl is rotatably supported by the frame of the door lock device 20 or the like, and is movable between an engaged position and a disengaged position. The engaged position is a position where the pawl is engaged with the latch 51, so as to hold the latch 51 at the latched position (in other words, rotational movement to the unlatched position is blocked). The disengaged position is a position where the pawl is not engaged with the latch 51, and is a position where the latch 51 is allowed to rotationally move to the unlatched position. In addition, the pawl is always elastically biased toward the engaged position by a pawl return spring.

The lift lever 52 is rotatably supported by the frame of the door lock device 20 or the like, and is movable, due to rotation thereof, between an initial position and an actuated position. When the lift lever 52 moves from the initial position to the actuated position, the pawl is pushed to move from the engaged position to the disengaged position. The lift lever 52 is always elastically biased toward the initial position by the biasing force of the pawl return spring transmitted via the pawl.

When the vehicle door 12 is in the closed state, the latch mechanism 50 holds the meshing state between the latch 51 and the striker 101 by locating the latch 51 at the latched position, and holds the latch 51 at the latched position by locating the pawl at the engaged position. Accordingly, the latch mechanism 50 holds the vehicle door 12 in the closed state with respect to the vehicle body 10. The state is the latched state of the latch mechanism 50. When the lift lever 52 moves from the initial position to the actuated position in a case where the vehicle door 12 is in the closed state and the latch mechanism 50 is in the latched state, the lift lever 52 pushes the pawl to move the pawl from the engaged position to the disengaged position. Accordingly, the engagement between the pawl and the latch 51 is released, the latch 51 is rotationally moved to the unlatched position by the biasing force of the latch return spring, and the closed state of the vehicle door 12 can be released. The state is the unlatched state of the latch mechanism 50. Accordingly, the latch mechanism 50 is switched from the latched state to the unlatched state by moving the lift lever 52 from the initial position to the actuated position.

### (Manual Switching Mechanism)

The manual switching mechanism includes the inside open lever 33, the inside lever 32, the outside open lever 36, and the open link 30.

The inside open lever 33 is rotationally movable between an initial position and an actuated position. FIGS. 4 to 8 and FIG. 11 show a state where the inside open lever 33 is located at the initial position. In FIGS. 4 to 8 and 11, the actuated position of the inside open lever 33 is a position obtained by clockwise rotating the initial position by a predetermined angle. The inside open lever 33 is always elastically biased toward the initial position by a biasing member (for example, a spring) (not shown).

The inside open lever 33 is linked to the inside door handle 131. For example, the inside open lever 33 and the inside door handle 131 are coupled to each other by an operation wire (not shown). In a state where the inside door handle 131 is located at the initial position, the inside open lever 33 is held at the initial position by the biasing member. When the inside door handle 131 is operated (that is, when the inside door handle 131 moves from the initial position to the actuated position), the inside open lever 33 moves from the initial position to the actuated position.

The inside open lever 33 includes a first engagement portion 331 and a second engagement portion 332. The first engagement portion 331 of the inside open lever 33 is engageable with a first engagement portion 321 of the inside lever 32. Then, when the inside open lever 33 moves from the initial position to the actuated position, the first engagement portion 331 of the inside open lever 33 is engaged with the first engagement portion 321 of the inside lever 32 to push the first engagement portion 321 of the inside lever 32.

The second engagement portion 332 of the inside open lever 33 is engageable with a fourth engagement portion 254 provided in the active lever 25. When the inside open lever 33 moves from the initial position toward the actuated position, the second engagement portion 332 of the inside open lever 33 is engaged with a third engagement portion 253 of the active lever 25 located at a mechanical link cut position (described later). Then, the second engagement portion 332 of the inside open lever 33 pushes the third engagement portion 253 of the active lever 25 to move the active lever 25 from the mechanical link cut position to a mechanical link position (described later).

The inside lever 32 is movable between an initial position and an actuated position by rotating with respect to the housing 21. FIGS. 4 to 8 and FIG. 11 show a state where the inside lever 32 is located at the initial position. In FIGS. 4 to 8 and FIG. 11, the actuated position of the inside lever 32 is a position obtained by rotationally counterclockwise moving the initial position by a predetermined angle.

The inside lever 32 includes the first engagement portion 321 and a second engagement portion 322. The first engagement portion 321 of the inside lever 32 is engageable with the first engagement portion 331 of the inside open lever 33. The second engagement portion 322 of the inside lever 32 is engageable with an engagement portion 362 of the outside open lever 36. Then, when the inside open lever 33 moves from the initial position to the actuated position, the first engagement portion 321 of the inside lever 32 is pushed by the first engagement portion 331 of the inside open lever 33, and the inside lever 32 moves from the initial position to the actuated position. When the inside lever 32 moves from the initial position to the actuated position, the second engagement portion 322 of the inside lever 32 is engaged with the engagement portion 362 of the outside open lever 36 to push the engagement portion 362 of the outside open lever 36.

The outside open lever 36 is movable between an initial position and an actuated position by rotating with respect to the housing 21. FIGS. 4 to 8 and FIG. 11 show a state where the outside open lever 36 is located at the initial position. A rotation center line of the outside open lever 36 is in a direction substantially parallel to the left and right in FIGS. 4 to 8 and FIG. 11. The outside open lever 36 is always elastically biased toward the initial position by the outside open lever biasing member 37.

The outside open lever 36 is linked to the outside door handle 141. Specifically, the outside open lever 36 is coupled to the outside door handle 141 by an operation wire. When the outside door handle 141 and the inside lever 32 are located at the initial position, the outside open lever 36 is held at the initial position by a biasing force of the outside open lever biasing member 37. When at least one of the outside door handle 141 and the inside lever 32 moves from the initial position to the actuated position, the outside open lever 36 moves from the initial position to the actuated position against the biasing force of the outside open lever biasing member 37.

The open link 30 is rotatably supported by a support portion 361 of the outside open lever 36. Therefore, the open link 30, together with the outside open lever 36, is relatively rotatable with respect to the housing 21, and is relatively rotatable with respect to the outside open lever 36. The open link 30 is movable between the mechanical link position and the mechanical link cut position by relatively rotating with respect to the outside open lever 36. The open link 30 includes a second engagement portion 302. The second engagement portion 302 of the open link 30 is engaged with an open link biasing member 31 to be described later. The open link 30 is linked to the active lever 25 via the open link biasing member 31, and is located at either the mechanical link position or the mechanical link cut position depending on whether the active lever 25 is located at either the mechanical link cut position or the mechanical link position. The second engagement portion 302 of the open link 30 has a protruding configuration protruding in a direction parallel to a relative rotation center line of the open link 30 with respect to the outside open lever 36 (toward a front side of a paper surface in FIGS. 4 to 8 and FIG. 11).

The open link 30 includes a first engagement portion 301 that is engageable with and disengageable from the lift lever 52 of the latch mechanism 50. When the outside open lever 36 moves from the initial position to the actuated position in a state where the open link 30 is located at the mechanical link position, the first engagement portion 301 of the open link 30 abuts against the lift lever 52 of the latch mechanism 50. Then, the first engagement portion 301 of the open link 30 moves the lift lever 52 from the initial position to the actuated position. Therefore, the latch mechanism 50 is switched from the latched state to the unlatched state. On the other hand, in a state where the open link 30 is located at the mechanical link cut position, even when the outside open lever 36 moves from the initial position to the actuated position, the first engagement portion 301 of the open link 30 does not abut against the lift lever 52 of the latch mechanism 50. Therefore, in this case, the lift lever 52 is held at the initial position. Therefore, the latch mechanism 50 is held in the latched state.

Accordingly, in a state where the open link 30 is located at the mechanical link position, the door lock device 20 can switch the latch mechanism 50 from the latched state to the unlatched state when the user manually operates either the outside door handle 141 or the inside door handle 131. Further, in a state where the open link 30 is located at the mechanical link cut position, the door lock device 20 cannot switch the latch mechanism 50 from the latched state to the unlatched state even when the user manually operates either the outside door handle 141 or the inside door handle 131. However, even in a state where the open link 30 is located at the mechanical link cut position, the latch mechanism 50 can be switched from the latched state to the unlatched state (described later) by performing a predetermined emergency unlatch operation on the inside door handle 131.

### (Automatic Switching Mechanism)

The automatic switching mechanism includes the motor 22, the rotating member 23, the blocking lever 38, the active lever 25, the control lever 26, and the release lever 29.

The motor 22 is a rotational driving force source of the rotating member 23, and generates a rotational driving force in both forward and reverse directions under control of a door lock ECU 601 to be described later. The motor 22 is fixed to the housing 21. A worm 222 is provided on a rotational shaft 221 of the motor 22, and the motor 22 rotates the rotating member 23 via the worm 222.

The rotating member 23 is a member interposed between the motor 22 and the active lever 25 and between the motor 22 and the release lever 29, and rotates forwardly or reversely by a rotational power transmitted from the motor 22. Specifically, the rotating member 23 is a worm wheel, and meshes with the worm 222 provided on the rotational shaft 221 of the motor 22. The worm 222 of the motor 22 and the rotating member 23 (the worm wheel) can be reversely driven. That is, in a state where the motor 22 is not energized (that is, in a state where the motor 22 is not driven), the rotating member 23 can be rotated by a biasing force of a rotating member biasing member 24 to be described later.

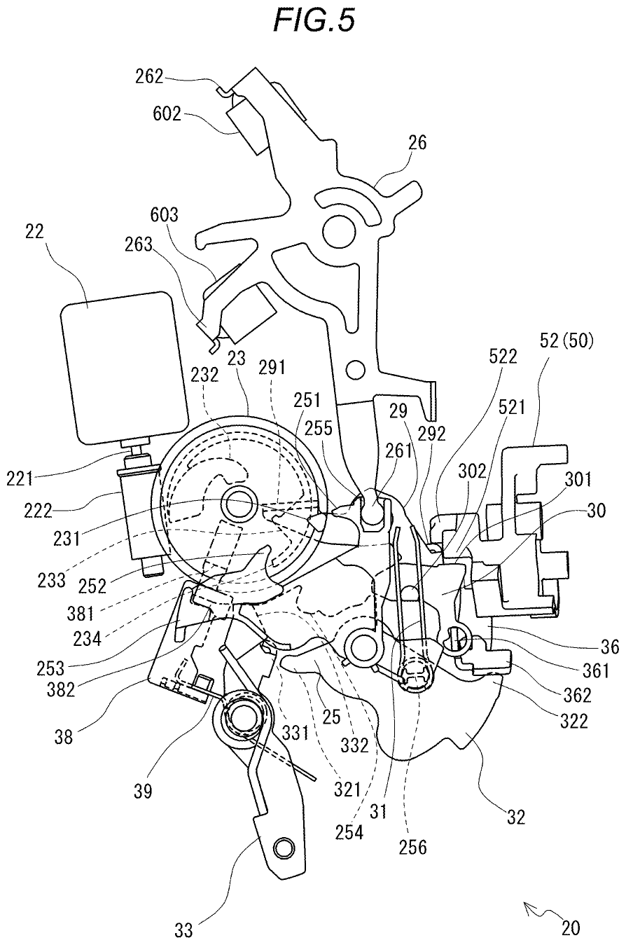

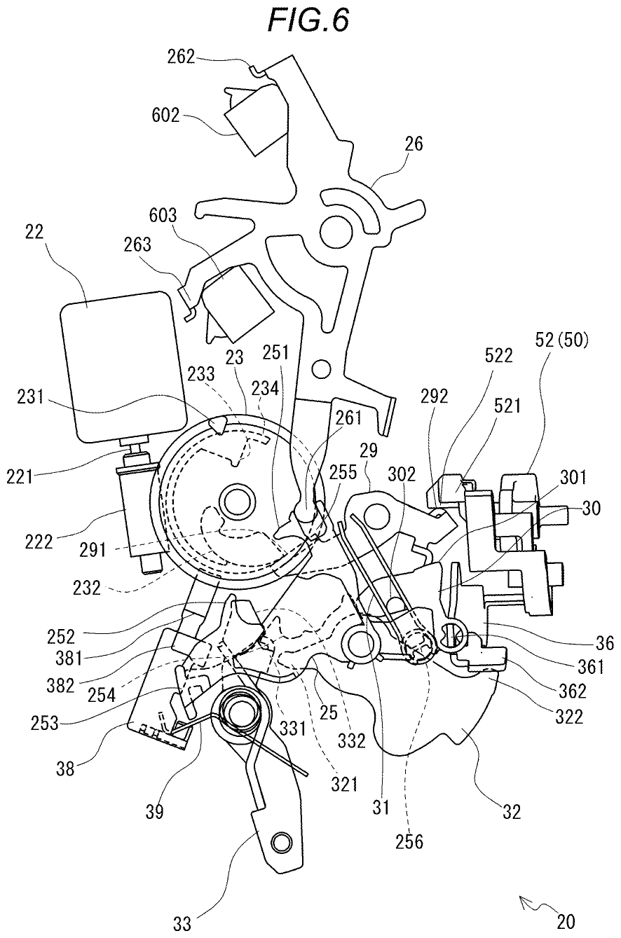

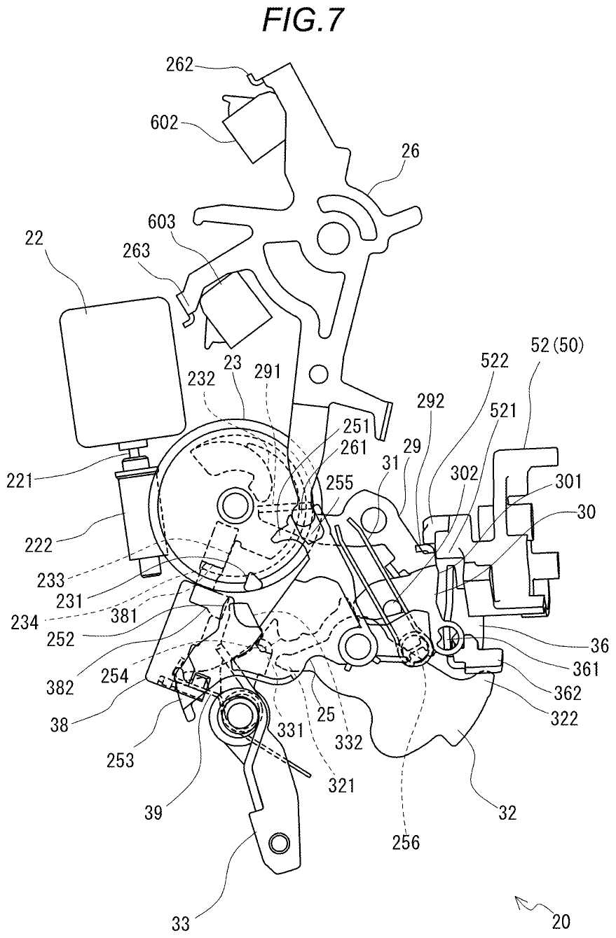

The rotating member 23 is always elastically biased by the rotating member biasing member 24 toward the neutral position shown in FIG. 4 with respect to a rotation direction (a circumferential direction of a circle centered on a center line of the first support portion 211). The rotating member 23 is rotationally movable, by the driving force of the motor 22, from the neutral position to a first rotational position shown in FIG. 5, a second rotational position shown in FIG. 6, and a third rotational position shown in FIG. 7. The first rotational position is a position obtained by rotating the neutral position in a predetermined direction (a counterclockwise direction in FIGS. 4 to 8 and FIG. 11). The second rotational position and the third rotational position are positions obtained by rotating the neutral position in a direction (a clockwise direction in FIGS. 4 to 8 and FIG. 11) opposite to the predetermined direction. The second rotational position is a position where a rotational angle from the neutral position is larger than that of the third rotational position. The neutral position is located between the first rotational position and the third rotational position.

Then, the rotating member 23 moves from the neutral position to the first rotational position under rotational driving of the motor 22 in a predetermined direction, and the rotating member 23 moves from the neutral position to the third rotational position or the second rotational position under rotational driving of the motor 22 in a direction opposite to the predetermined direction. After the rotating member 23 is moved from the neutral position to the first rotational position, the second rotational position, or the third rotational position under the rotational driving of the motor 22, when the rotational driving of the motor 22 is stopped (when the energization to the motor 22 is stopped), the rotating member 23 moves to the neutral position by the biasing force of the rotating member biasing member 24.

The rotating member 23 includes a first engagement portion 231, a second engagement portion 232, a third engagement portion 233, and a fourth engagement portion 234. The first engagement portion 231 of the rotating member 23 has a protruding configuration protruding toward one side in an axial direction of the rotating member 23, and is selectively engageable with either a first engagement portion 251 or a second engagement portion 252 of the active lever 25 to be described later. The second engagement portion 232 of the rotating member 23 has a protruding configuration protruding to a side opposite to the side to which the first engagement portion 231 protrudes, and is engageable with the first engagement portion 291 of the release lever 29. The third engagement portion 233 of the rotating member 23 has a protruding structure protruding to the same side as the second engagement portion 232, and can abut against the blocking lever 38. However, the third engagement portion 233 of the rotating member 23 is not engaged with the release lever 29 regardless of the position of the rotating member 23. The fourth engagement portion 234 of the rotating member 23 has a protruding configuration protruding to the same side as the second engagement portion 232 and the third engagement portion 233, and is engageable with the first engagement portion 381 of the blocking lever 38 located at the blocking position.

The rotating member biasing member 24 elastically biases the rotating member 23 toward the neutral position. The rotating member biasing member 24 is a torsion coil spring having an arm at each of two ends thereof. One arm of the torsion coil spring is engaged with the rotating member 23, and the other arm is engaged with the housing 21.

When the rotating member 23 is moved from the neutral position to the third rotational position under the rotational driving of the motor 22, the blocking lever 38 blocks the rotating member 23 from moving to the second rotational position exceeding the third rotational position. The blocking lever 38 is substantially formed in a rod shape, and is supported by a guide provided in the housing 21 so as to linearly reciprocate with respect to the housing 21. The blocking lever 38 can linearly move with respect to the housing 21 so as to move between a retracted position shown in FIGS. 4 and 6 and a blocking position shown in FIGS. 5, 7, 8, and 11. The blocking position is not a position of a specific point but a position having a certain range.

The retracted position is a position where the rotation of the rotating member 23 is not blocked, and specifically, is a position outside rotation trajectories of the third engagement portion 233 and the fourth engagement portion 234 of the rotating member 23. The blocking position is a position where the blocking lever 38 abuts against the third engagement portion 233 of the rotating member 23 and is engaged with the fourth engagement portion 234 of the rotating member 23 so as to block the rotating member 23 from rotationally moving from the neutral position or the third rotational position toward the second rotational position. Specifically, the blocking position is a position where at least a part of the blocking lever 38 enters the movement trajectories of the third engagement portion 233 and the fourth engagement portion 234 of the rotating member 23, and is a position where a part of the blocking lever 38 abuts against a side surface of the third engagement portion 233 of the rotating member 23 located at the third rotational position (a surface located on a front side in the rotation direction when the rotating member 23 rotates from the neutral position toward the third rotational position).

The blocking lever 38 includes the first engagement portion 381 and a second engagement portion 382. The first engagement portion 381 of the blocking lever 38 is a stepped surface engageable with the fourth engagement portion 234 of the rotating member 23. In a state where the blocking lever 38 is located at the blocking position, the first engagement portion 381 of the blocking lever 38 is located radially inward of a trajectory of the rotational movement of the fourth engagement portion 234 of the rotating member 23. Therefore, in a state where the blocking lever 38 is located at the blocking position, the fourth engagement portion 234 of the rotating member 23 is engageable with the first engagement portion 381 of the blocking lever 38 located at the blocking position by rotationally moving the rotating member 23 from the neutral position to the third rotational position. In a state where the fourth engagement portion 234 of the rotating member 23 is engaged with the first engagement portion 381 of the blocking lever 38 (that is, in a state where the fourth engagement portion 234 of the rotating member 23 is present at a retracted position side of the first engagement portion 381 of the blocking lever 38), the blocking lever 38 cannot move to the retracted position and is held at the blocking position.

The second engagement portion 382 of the blocking lever 38 is engageable with the third engagement portion 253 of the active lever 25.

The blocking lever biasing member 39 always elastically biases the blocking lever 38 toward the retracted position. The blocking lever biasing member 39 is a torsion coil spring having an arm at each of two ends thereof. One arm is engaged with the blocking lever 38, and the other arm is engaged with the housing 21. A biasing force of the blocking lever biasing member 39 is smaller than that of the detent spring 40 that biases the active lever 25 to be described later.

The active lever 25 is moveable, due to rotation thereof, between the mechanical link cut position, which is a first position, and the mechanical link position, which is a second position. FIGS. 4, 6, and 7 show a state where the active lever 25 is located at the mechanical link cut position, and FIGS. 5, 8, 9, and 11 show a state where the active lever 25 is located at the mechanical link position. The active lever 25 is selectively elastically biased toward either the mechanical link cut position or the mechanical link position by the detent spring 40 (see FIG. 2). Specifically, the active lever 25 is elastically biased toward the mechanical link cut position by the detent spring 40 on a side closer to the mechanical link cut position than to a predetermined intermediate point between the mechanical link cut position and the mechanical link position. On the other hand, the active lever 25 is elastically biased toward the mechanical link position by the detent spring 40 on a side closer to the mechanical link position than to the predetermined intermediate point. Therefore, the active lever 25 is held at the mechanical link position or the mechanical link cut position in a state where no external force other than that from the detent spring 40 is applied.

The active lever 25 includes the first engagement portion 251, the second engagement portion 252, the third engagement portion 253, and the fourth engagement portion 254. The first engagement portion 251 of the active lever 25 is engageable with the first engagement portion 231 of the rotating member 23. As shown in FIG. 4, in a state where the active lever 25 is located at the mechanical link cut position, the first engagement portion 251 of the active lever 25 is located on a movement trajectory of the first engagement portion 231 of the rotating member 23 and on a first rotational position side (the counterclockwise direction side in the drawing) of the first engagement portion 231 of the rotating member 23 located at the neutral position. In a state where the active lever 25 is located at the mechanical link cut position, when the rotating member 23 moves from the neutral position toward the first rotational position, the first engagement portion 251 of the active lever 25 is pushed by the first engagement portion 231 of the rotating member 23. Therefore, the active lever 25 moves toward the mechanical link position. Then, when the active lever 25 moves to a side closer to the mechanical link position than to the predetermined intermediate point between the mechanical link cut position and the mechanical link position, the active lever 25 moves to the mechanical link position by the elastic biasing force of the detent spring 40.

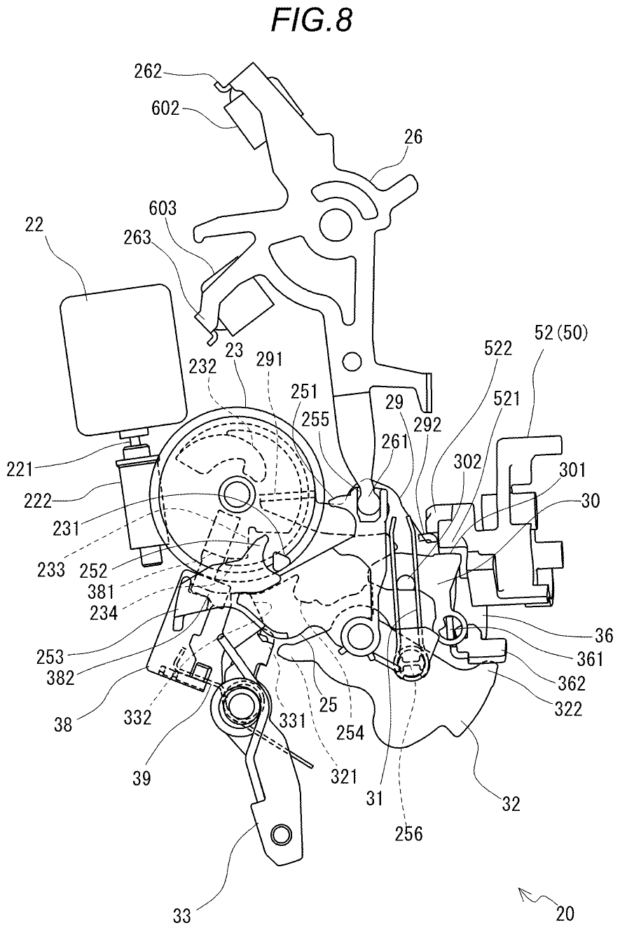

The second engagement portion 252 of the active lever 25 is engageable with the first engagement portion 231 of the rotating member 23. As shown in FIG. 8, in a state where the active lever 25 is located at the mechanical link position, the second engagement portion 252 of the active lever 25 is located on the movement trajectory of the first engagement portion 231 of the rotating member 23 and on a third rotational position side (the clockwise direction side in the drawing) of the first engagement portion 231 of the rotating member 23 located at the neutral position. In a state where the active lever 25 is located at the mechanical link position, when the rotating member 23 moves from the neutral position toward the third rotational position, the second engagement portion 252 of the active lever 25 is pushed by the first engagement portion 231 of the rotating member 23. Therefore, the active lever 25 moves toward the mechanical link cut position. Then, when the active lever 25 moves to a side closer to the mechanical link cut position than to the predetermined intermediate point between the mechanical link position and the mechanical link cut position, the active lever 25 moves to the mechanical link cut position by the elastic biasing force of the detent spring 40.

As shown in FIGS. 4 and 8, when the rotating member 23 is located at the neutral position, the first engagement portion 251 and the second engagement portion 252 of the active lever 25 are separated from the first engagement portion 231 of the rotating member 23 instead of being engaged with the first engagement portion 231 of the rotating member 23 regardless of whether the active lever 25 is located at the mechanical link cut position or the mechanical link position.

The third engagement portion 253 of the active lever 25 is engageable with the second engagement portion 382 of the blocking lever 38. When the active lever 25 is located at the mechanical link cut position, the third engagement portion 253 of the active lever 25 is not engaged with the second engagement portion 382 of the blocking lever 38. Therefore, the blocking lever 38 can move to the retracted position. When the active lever 25 moves from the mechanical link cut position to the mechanical link position, the third engagement portion 253 of the active lever 25 abuts against the second engagement portion 382 of the blocking lever 38, and the blocking lever 38 is moved from the retracted position to the blocking position against the biasing force of the blocking lever biasing member 39. When the active lever 25 is located at the mechanical link position, the blocking lever 38 is held at the blocking position.

The active lever 25 is linked to the open link 30 via the open link biasing member 31. Specifically, the open link biasing member 31 is a torsion coil spring having an arm at each of two ends thereof. Two arms of the open link biasing member 31 are substantially parallel to each other, and can be elastically deformed such that a distance between the two arms increases. The second engagement portion 302 of the open link 30 is sandwiched between the two arms of the open link biasing member 31. When the active lever 25 is located at the mechanical link cut position, the open link 30 is elastically biased to the mechanical link cut position by the open link biasing member 31, and when the active lever 25 is located at the mechanical link position, the open link 30 is elastically biased to the mechanical link position by the open link biasing member 31. The active lever 25 is provided with an attachment portion 256, and the open link biasing member 31 is attached to the attachment portion 256.

A fifth engagement portion 255 of the active lever 25 is engaged with a first arm portion 261 of the control lever 26.

The control lever 26 rotates in conjunction with the active lever 25. Similar to the active lever 25, a position of the control lever 26 when the active lever 25 is located at the mechanical link cut position is referred to as a “mechanical link cut position”, and a position of the control lever 26 when the active lever 25 is located at the mechanical link position is referred to as a “mechanical link position”.

The control lever 26 includes the first arm portion 261, a second arm portion 262, and a third arm portion 263. The first arm portion 261 is engaged with the fifth engagement portion 255 of the active lever 25. The second arm portion 262 is a portion for switching ON and OFF of a first position switch 602. The third arm portion 263 is a portion for switching ON and OFF of a second position switch 603. When the control lever 26 is located at the mechanical link cut position, the second arm portion 262 and the third arm portion 263 do not come into contact with operating elements of the first position switch 602 and the second position switch 603, respectively. Therefore, the first position switch 602 and the second position switch 603 are held in an OFF state. When the control lever 26 moves to the mechanical link position, the second arm portion 262 and the third arm portion 263 come into contact with the operating elements of the first position switch 602 and the second position switch 603, respectively. Therefore, the first position switch 602 and the second position switch 603 are switched to ON.

The control lever 26 is linked to the key cylinder 142 via the key switch lever 27 and the outside locking lever 28 (see FIG. 3). Therefore, the user of the vehicle can move the control lever 26 and the active lever 25 from the mechanical link position to the mechanical link cut position by inserting the key into the key cylinder 142 and rotating the key in a predetermined direction. Similarly, the user of the vehicle can move the control lever 26 and the active lever 25 from the mechanical link cut position to the mechanical link position by inserting the key into the key cylinder 142 and rotating the key in a direction opposite to the predetermined direction.

The release lever 29 is movable between the initial position shown in FIGS. 4, 5, 7, 8, and 11 and the actuated position shown in FIG. 6 by rotating with respect to the housing 21. The release lever 29 includes the first engagement portion 291 and a second engagement portion 292. The first engagement portion 291 of the release lever 29 is engageable with the second engagement portion 232 of the rotating member 23. The second engagement portion 292 of the release lever 29 is engageable with a second engagement portion 522 of the lift lever 52. When the rotating member 23 rotationally moves from the neutral position toward the second rotational position exceeding the third rotational position, the first engagement portion 291 of the release lever 29 is engaged with the second engagement portion 232 of the rotating member 23 and is pushed by the second engagement portion 232 of the rotating member 23. Accordingly, the release lever 29 moves from the initial position toward the actuated position. When the release lever 29 moves from the initial position to the actuated position, the second engagement portion 292 of the release lever 29 is engaged with the second engagement portion 522 of the lift lever 52 of the latch mechanism 50 to push the second engagement portion 522 of the lift lever 52, thereby moving the lift lever 52 from the initial position to the actuated position.

Accordingly, the release lever 29 moves (rotates) from the initial position to the actuated position in conjunction with the rotational movement of the rotating member 23 from the neutral position to the second rotational position, thereby switching the latch mechanism 50 from the latched state to the unlatched state. The release lever 29 directly pushes the lift lever 52 without through the open link 30. That is, the release lever 29 can move the lift lever 52 from the initial position to the actuated position regardless of whether the open link 30 is located at the mechanical link position or the mechanical link cut position.

### (System Configuration)

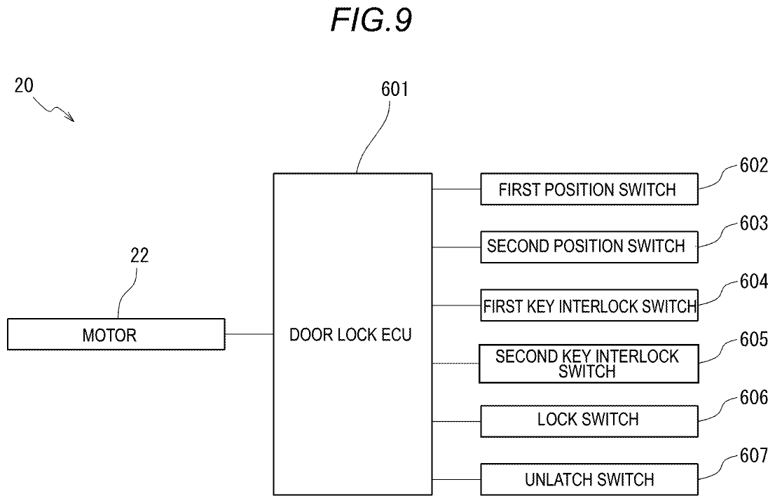

FIG. 9 is a diagram showing a control system of the door lock device 20. As shown in FIG. 9, the door lock device 20 includes the door lock ECU 601, the first position switch 602, the second position switch 603, a first key interlock switch 604, a second key interlock switch 605, a lock switch 606, and an unlatch switch 607.

The door lock ECU 601 is a control unit that rotationally drives the motor 22, and includes a microcomputer. The microcomputer includes a CPU, a ROM, a RAM, a nonvolatile memory, an interface (I/F), and the like. The CPU can read instructions, programs, or routines stored in the ROM, load the instructions, programs, or routines in the RAM, and execute the instructions, programs, or routines.

The first position switch 602 and the second position switch 603 are switches for detecting the position of the control lever 26. The first position switch 602 and the second position switch 603 are switched to OFF when the control lever 26 is located at the mechanical link cut position, and are switched to ON when the control lever 26 is located at the mechanical link position. Then, the door lock ECU 601 can acquire whether the first position switch 602 and the second position switch 603 are OFF or ON, and can determine whether the control lever 26 is located at the mechanical link cut position or the mechanical link position based on the acquired ON and OFF states of the first position switch 602 and the second position switch 603.

The first key interlock switch 604 is switched to OFF when the key cylinder 142 is located at the neutral position, and is switched to ON when the key cylinder 142 rotates from the neutral position in a predetermined direction (specifically, a direction in which the control lever 26 moves to the mechanical link position). The second key interlock switch 605 is switched to OFF when the key cylinder 142 is located at the neutral position, and is switched to ON when the key cylinder 142 rotates from the neutral position in a direction opposite to the predetermined direction (specifically, a direction in which the control lever 26 moves to the mechanical link cut position). The door lock ECU 601 can detect whether the first key interlock switch 604 and the second key interlock switch 605 are ON or OFF (that is, whether the key cylinder 142 is being operated).

The lock switch 606 is an electrical switch operated by the user to “switch the door lock device 20 to either the mechanical link state or the mechanical link cut state” and “switch the mode of the door lock device 20 to either an unlatch permission mode or an unlatch non-permission mode when the door lock device 20 is in the mechanical link cut state”. The door lock ECU 601 can detect whether an operation is performed on the lock switch 606 to switch the door lock device 20 to the unlatch permission mode, whether an operation is performed on the lock switch 606 to switch the door lock device 20 to the unlatch non-permission mode, and whether an operation is performed on the lock switch 606 to switch the door lock device 20 from the mechanical link state to the mechanical link cut state. The unlatch switch 607 is an electrical switch operated by the user to switch the latch mechanism 50 to the unlatched state (to bring the vehicle door 12 into an openable state). The door lock ECU 601 can detect whether an operation is performed on the unlatch switch 607 to switch the latch mechanism 50 to the unlatched state.

### (Operation of Door Lock Device)

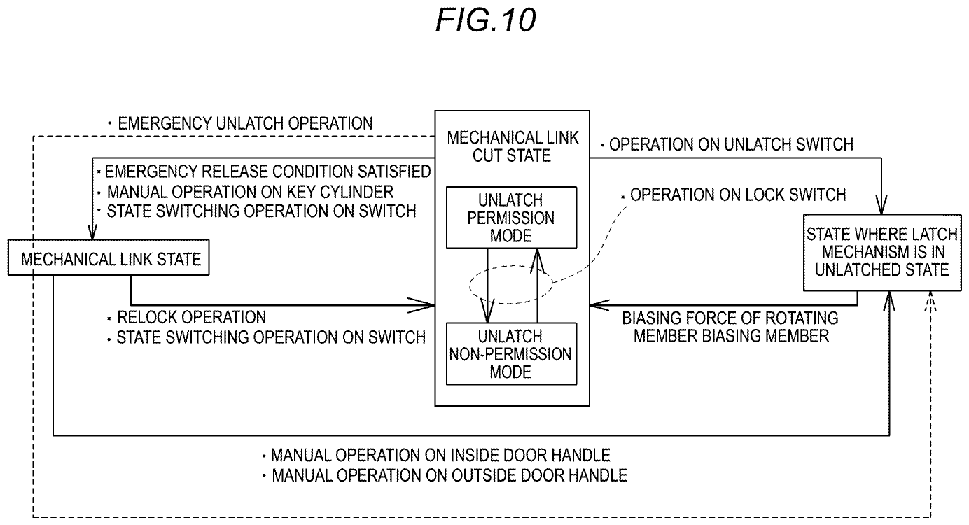

Next, operations of the door lock device 20 will be described. FIG. 10 is a diagram showing state transition of the door lock device 20. As described above, the door lock device 20 can be switched to three states including the mechanical link state, the mechanical link cut state, and the “state where the latch mechanism 50 is in the unlatched state”. In the mechanical link cut state and the mechanical link state, the latch mechanism 50 is in the latched state. When the door lock device 20 is in the mechanical link cut state, the door lock ECU 601 controls the door lock device 20 in either the unlatch permission mode or the unlatch non-permission mode. The unlatch permission mode is a state (mode) where the latch mechanism 50 can be switched from the latched state to the unlatched state by the user performing an operation on the unlatch switch 607. The unlatch non-permission mode is a state (mode) where the latch mechanism 50 cannot be switched from the latched state to the unlatched state by the user performing an operation on the unlatch switch 607. The user can select either the unlatch permission mode or the unlatch non-permission mode by operating the lock switch 606.

### (Mechanical Link Cut State)

As shown in FIG. 4, the mechanical link cut state of the door lock device 20 is a state where the rotating member 23 is located at the neutral position, the active lever 25 is located at the mechanical link cut position, and the blocking lever 38 is located at the retracted position. The door lock ECU 601 generally maintains the door lock device 20 in the mechanical link cut state. When both the first position switch 602 and the second position switch 603 are OFF, the door lock ECU 601 determines that the door lock device 20 is in the mechanical link cut state.

When the rotating member 23 is located at the neutral position, the first engagement portion 381 of the blocking lever 38 and the fourth engagement portion 234 of the rotating member 23 are not engaged with each other. When the active lever 25 is located at the mechanical link cut position, the blocking lever 38 is allowed to move to the retracted position. Therefore, the blocking lever 38 is held at the retracted position by the biasing force of the blocking lever biasing member 39.

When the door lock device 20 is in the mechanical link cut state, the active lever 25 is held at the mechanical link cut position by the biasing force of the detent spring 40. Further, when the active lever 25 is located at the mechanical link cut position, the open link 30 is held at the mechanical link cut position by the open link biasing member 31 attached to the active lever 25.

When the inside door handle 131 is manually operated in the mechanical link cut state, the movement of the inside door handle 131 is transmitted to the outside open lever 36 via the inside open lever 33 and the inside lever 32, and the outside open lever 36 moves from the initial position to the actuated position. However, since the open link 30 is located at the mechanical link cut position, the open link 30 is not engaged with the first engagement portion 521 of the lift lever 52 even when the open link 30 moves along with the movement of the outside open lever 36 from the initial position to the actuated position. Therefore, the lift lever 52 does not move from the initial position, and the latch mechanism 50 is held in the latched state. That is, the latch mechanism 50 cannot be switched from the latched state to the unlatched state during the door opening operation of the inside door handle 131 and the outside door handle 141.

### (Mechanical Link State)

As shown in FIG. 8, the mechanical link state of the door lock device 20 is a state where the rotating member 23 is located at the neutral position, the active lever 25 and the control lever 26 are located at the mechanical link position, and the blocking lever 38 is located at the blocking position. In this state, both the first position switch 602 and the second position switch 603 are ON.

(Switching from Mechanical Link Cut State to “State where Latch Mechanism is in Unlatched State”)

When the door lock device 20 is in the unlatch permission mode in the mechanical link cut state, the door lock ECU 601 switches the latch mechanism 50 from the latched state to the unlatched state when detecting that an operation for unlatching the latch mechanism 50 is performed on the unlatch switch 607. Specifically, the door lock ECU 601 drives the motor 22 to move the rotating member 23 from the neutral position to the second rotational position. As shown in FIG. 4, since the blocking lever 38 is located at the retracted position in the mechanical link cut state, the rotating member 23 can move from the neutral position to the second rotational position exceeding the third rotational position.

As shown in FIG. 6, when the rotating member 23 moves from the neutral position to the second rotational position, the second engagement portion 232 of the rotating member 23 pushes the first engagement portion 291 of the release lever 29 to move the release lever 29 from the initial position to the actuated position. When the release lever 29 moves from the initial position to the actuated position, the release lever 29 pushes the lift lever 52, and the lift lever 52 moves from the initial position to the actuated position. As a result, the latch mechanism 50 is switched from the latched state to the unlatched state.

When the rotating member 23 reaches the second rotational position, the door lock ECU 601 stops driving the motor 22. Therefore, the rotating member 23 returns from the second rotational position to the neutral position by the biasing force of the rotating member biasing member 24. Accordingly, the latch mechanism 50 returns from the unlatched state to the latched state, and as a result, the door lock device 20 is switched from the “state where the latch mechanism 50 is in the unlatched state” to the mechanical link cut state.

When the door lock device 20 is in the mechanical link cut state and the control mode is the unlatch non-permission mode, the door lock ECU 601 does not switch the door lock device 20 from the mechanical link cut state to the “state where the latch mechanism 50 is in the unlatched state” even when an operation on the unlatch switch 607 is detected. That is, the door lock ECU 601 maintains the door lock device 20 in the mechanical link cut state.

(Switching from Mechanical Link Cut State to Mechanical Link State)

As shown in FIG. 10, when it is detected that a predetermined condition (hereinafter, sometimes referred to as an “emergency release condition”) is satisfied in the mechanical link cut state, the door lock ECU 601 switches the door lock device 20 from the mechanical link cut state to the mechanical link state. For example, when it is determined that the vehicle collides with an object or when the voltage (charge amount) of the battery is equal to or less than a threshold value, the door lock ECU 601 determines that the emergency release condition is satisfied, and switches the door lock device 20 from the mechanical link cut state to the mechanical link state. In addition, when “an operation of switching the door lock device 20 from the mechanical link cut state to the mechanical link state” on the lock switch 606 is detected, the door lock ECU 601 switches the door lock device 20 from the mechanical link cut state to the mechanical link state. Accordingly, the user can switch the latch mechanism 50 to the unlatched state by the door opening operation of the inside door handle 131 or the outside door handle 141.

Specifically, the door lock ECU 601 drives the motor 22 to move the rotating member 23 from the neutral position to the first rotational position. FIG. 5 shows a state where the rotating member 23 moves to the first rotational position. As shown in FIG. 5, when the rotating member 23 moves from the neutral position toward the first rotational position, the first engagement portion 231 of the rotating member 23 is engaged with the first engagement portion 251 of the active lever 25 at the mechanical link cut position and pushes the first engagement portion 251. Therefore, the active lever 25 rotationally moves from the mechanical link cut position toward the mechanical link position. Then, when the active lever 25 passes through the predetermined intermediate point between the mechanical link cut position and the mechanical link position, the active lever 25 moves to the mechanical link position by the biasing force of the detent spring 40. Then, the active lever 25 abuts against a stopper or the like at the mechanical link position and is positioned at the mechanical link position. When the active lever 25 moves from the mechanical link cut position to the mechanical link position, the operation of the active lever 25 is transmitted to the open link 30 via the open link biasing member 31, and the open link 30 moves from the mechanical link cut position to the mechanical link position.

When the active lever 25 moves from the mechanical link cut position to the mechanical link position, the control lever 26 also moves, in conjunction with the movement, from the mechanical link cut position to the mechanical link position. As a result, the first position switch 602 and the second position switch 603 are switched from OFF to ON. Further, after a predetermined time elapses from the start of the driving of the motor 22, the rotational driving of the motor 22 is stopped. When the rotational driving of the motor 22 is stopped, the rotating member 23 moves to the neutral position by the biasing force of the rotating member biasing member 24. However, the active lever 25 is held at the mechanical link position by the biasing force of the detent spring 40. Further, since the active lever 25 is held at the mechanical link position, the blocking lever 38 is held at the blocking position. Accordingly, when the rotating member 23 moves from the neutral position to the first rotational position, the door lock device 20 is switched from the mechanical link cut state to the mechanical link state.

The door lock device 20 can also be switched from the mechanical link cut state to the mechanical link state by the operation of the inside door handle 131. Specifically, in a case where the door lock device 20 is in the mechanical link cut state, when the inside door handle 131 is operated (moves from the initial position to the actuated position), the inside open lever 33 moves from the initial position to the actuated position in conjunction with the operation of the inside door handle 131. Accordingly, the second engagement portion 332 of the inside open lever 33 pushes the fourth engagement portion 254 of the active lever 25 to move the active lever 25 from the mechanical link cut position to the mechanical link position. As a result, the door lock device 20 is switched from the mechanical link cut state to the mechanical link state. Further, as described above, the door lock device 20 can also be switched from the mechanical link cut state to the mechanical link state by the manual operation on the key cylinder 142.

(Operation of Switching from Mechanical Link State to Mechanical Link Cut State)

As shown in FIG. 10, when a predetermined condition (hereinafter, sometimes referred to as a “relock condition”) is satisfied, the door lock ECU 601 switches the door lock device 20 from the mechanical link state to the mechanical link cut state. A method for determining whether the relock condition is satisfied is as follows. When a predetermined time (for example, one second) elapses after the door lock device 20 is switched to the mechanical link state by a manual operation on the inside door handle 131 or an operation on the key cylinder 142 (an operation on the control lever 26 via the key cylinder 142), the door lock ECU 601 determines that the relock condition is satisfied. For example, when it is detected that the first position switch 602 and the second position switch 603 are switched from OFF to ON without detecting an “operation of switching the door lock device 20 from the mechanical link cut state to the mechanical link state” on the lock switch 606, the door lock ECU 601 determines that the door lock device 20 is switched to the mechanical link state by the manual operation on the inside door handle 131. Similarly, when it is detected that the first key interlock switch 604 is switched to ON and the first position switch 602 and the second position switch 603 are switched from OFF to ON, the door lock ECU 601 determines that the door lock device 20 is switched to the mechanical link state by the manual operation on the key cylinder 142. Then, when a predetermined time (for example, one second) elapses after the door lock device 20 is switched to the mechanical link state, the door lock ECU 601 determines that the relock condition is satisfied.

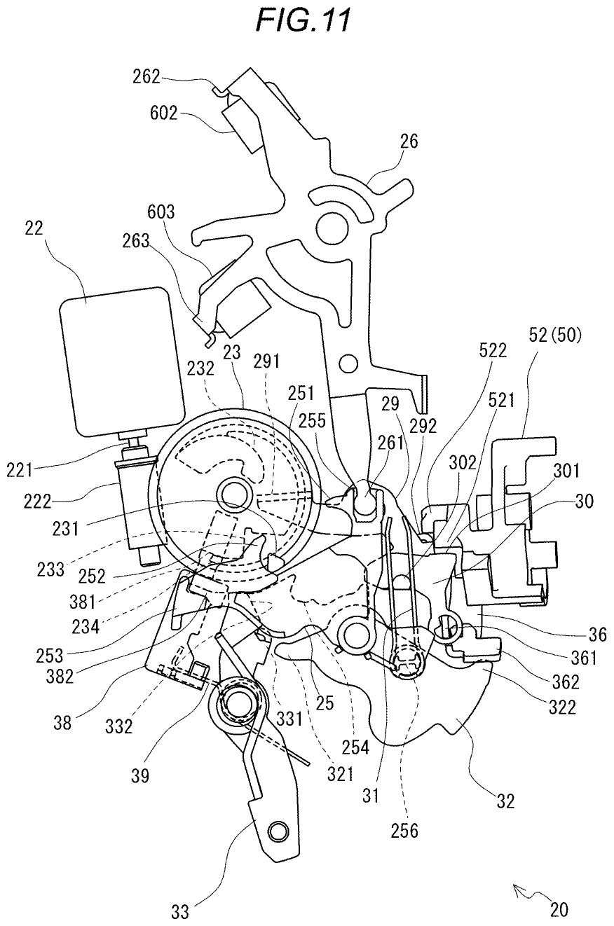

When it is determined that the relock condition is satisfied, the door lock ECU 601 drives the motor 22 to rotate the rotating member 23 from the neutral position shown in FIG. 8 toward the third rotational position. FIG. 11 shows a state where the rotating member 23 rotates by a predetermined amount from the neutral position toward the third rotational position. When the rotating member 23 rotates by a predetermined amount from the neutral position toward the third rotational position by the rotational driving force of the motor 22, as shown in FIG. 11, the fourth engagement portion 234 of the rotating member 23 is engaged with the first engagement portion 381 of the blocking lever 38 before the first engagement portion 231 of the rotating member 23 is engaged with the second engagement portion 252 of the active lever 25. When the fourth engagement portion 234 of the rotating member 23 is engaged with the first engagement portion 381 of the blocking lever 38, the blocking lever 38 cannot move from the blocking position to the retracted position.

FIG. 7 is a diagram showing a state where the rotating member 23 further rotates from the position shown in FIG. 11 and reaches the third rotational position. When the rotating member 23 reaches the third rotational position, the first engagement portion 231 of the rotating member 23 pushes the second engagement portion 252 of the active lever 25, and the active lever 25 moves from the mechanical link position toward the mechanical link cut position. Then, when the active lever 25 passes through the intermediate point between the mechanical link position and the mechanical link cut position, the active lever 25 moves to the mechanical link cut position by the biasing force of the detent spring 40, abuts against the stopper or the like, and is positioned at the mechanical link cut position.

When the active lever 25 moves to the mechanical link cut position, the first position switch 602 and the second position switch 603 are switched from ON to OFF. When a predetermined time elapses from the start of the rotational driving of the motor 22, the door lock ECU 601 stops the rotational driving of the motor 22 (stops the energization of the motor 22). The “predetermined time” is a time required by the rotating member 23 to move from the neutral position to the third rotational position under the rotational driving of the motor 22. Even after the rotational driving of the motor 22 is stopped, the rotation of the rotating member 23 may continue due to inertia. Therefore, the rotating member 23 attempts to move, due to inertia, toward the second rotational position after passing through the third rotational position. In addition, when the active lever 25 moves from the mechanical link position to the mechanical link cut position, since the engagement between the third engagement portion 253 of the active lever 25 and the second engagement portion 382 of the blocking lever 38 is released, the blocking lever 38 attempts to move from the blocking position to the retracted position by the biasing force of the blocking lever biasing member 39.

However, when the active lever 25 moves from the mechanical link position to the mechanical link cut position, the first engagement portion 381 of the blocking lever 38 and the fourth engagement portion 234 of the rotating member 23 are already engaged with each other. Therefore, the blocking lever 38 cannot move from the blocking position to the retracted position. Accordingly, the blocking lever 38 is held at the blocking position. Since the blocking lever 38 is located at the blocking position, the rotating member 23 abuts against the blocking lever 38 at the third rotational position, and the movement of the rotating member 23 is blocked. Specifically, at the third rotational position, the third engagement portion 233 of the rotating member 23 abuts against a side wall constituting one side surface of the blocking lever 38. Therefore, the blocking lever 38 blocks the rotating member 23 from passing through the third rotational position (that is, from moving to a side closer to the second rotational position than to the third rotational position).

After the rotational driving of the motor 22 is stopped and the above inertia of the rotating member 23 disappears, the rotating member 23 moves to the neutral position by the biasing force of the rotating member biasing member 24. When the rotating member 23 moves to the neutral position, the engagement between the fourth engagement portion 234 of the rotating member 23 and the first engagement portion 381 of the blocking lever 38 is released. Therefore, the blocking lever 38 moves from the blocking position to the retracted position by the biasing force of the blocking lever biasing member 39, and the door lock device 20 is brought into the mechanical link cut state shown in FIG. 4.

Accordingly, when a predetermined time elapses after the door lock device 20 is switched from the mechanical link cut state to the mechanical link state by the operation on the inside door handle 131 or the key cylinder 142, the door lock ECU 601 determines that the relock condition is satisfied. Then, the door lock ECU 601 switches the door lock device 20 from the mechanical link state to the mechanical link cut state. This operation is a relock operation. By such an operation, the door lock ECU 601 holds the door lock device 20 in the mechanical link cut state. In other words, the door lock device 20 is generally held in the mechanical link cut state.

(Operation of Switching from Mechanical Link State to “State where Latch Mechanism is in Unlatched State”)

When an operation on the unlatch switch 607 is detected, the door lock ECU 601 switches the door lock device 20 from the mechanical link state to the “state where the latch mechanism 50 is in the unlatched state”. However, the door lock device 20 cannot be directly switched from the mechanical link state to the “state where the latch mechanism 50 is in the unlatched state” by the driving force of the motor 22. Therefore, the door lock ECU 601 temporarily switches the door lock device 20 from the mechanical link state to the mechanical link cut state, and then switches the door lock device 20 from the mechanical link cut state to the “state where the latch mechanism 50 is in the unlatched state”. The operation of switching the door lock device 20 from the mechanical link state to the mechanical link cut state by the driving force of the motor 22 and the operation of switching the door lock device 20 from the mechanical link cut state to the “state where the latch mechanism 50 is in the unlatched state” are as described above.

Specifically, the door lock ECU 601 moves the rotating member 23 of the door lock device 20 in the mechanical link state from the neutral position to the third rotational position by forwardly rotating the motor 22, and then moves the rotating member 23 to the second rotational position. When the door lock device 20 is in the mechanical link state, the blocking lever 38 is located at the blocking position. Therefore, when the rotating member 23 rotates from the neutral position toward the second rotational position, the rotating member 23 is blocked at the third rotational position by the blocking lever from further rotating. Accordingly, the rotating member 23 cannot directly move from the neutral position to the second rotational position exceeding the third rotational position. Therefore, the rotating member 23 moves from the neutral position to the third rotational position, and then the rotational driving of the motor 22 is stopped. When the rotational driving of the motor 22 is stopped, the rotating member 23 returns to the neutral position by the biasing force of the rotating member biasing member 24. Thereafter, the door lock ECU 601 rotationally drives the motor 22 again to move the rotating member 23 to the second rotational position. By such an operation, the door lock device 20 is switched to the “state where the latch mechanism 50 is in the unlatched state”.

When the door lock device 20 is in the mechanical link state, as described above, the door lock device 20 can be switched to the “state where the latch mechanism 50 is in the unlatched state” by the door opening operation on the outside door handle 141 or the inside door handle 131.

### (Emergency Unlatch Operation)

The emergency unlatch operation is a manual operation on the inside door handle 131 for switching, when the door lock device 20 is in the mechanical link cut state, the door lock device 20 from the mechanical link cut state to the “state where the latch mechanism 50 is in the unlatched state”. As described above, when the inside door handle 131 is operated in a case where the door lock device 20 is in the mechanical link cut state, the door lock device 20 is switched from the mechanical link cut state to the mechanical link state. Then, when the inside door handle 131 is operated in a case where the door lock device 20 is in the mechanical link state, the door lock device 20 is switched from the mechanical link state to the “state where the latch mechanism 50 is in the unlatched state”. However, in a case where the door lock device 20 is switched from the mechanical link cut state to the mechanical link state by operating the inside door handle 131, when a predetermined time elapses after the switching, the relock condition is satisfied. Then, when the relock condition is satisfied, the door lock ECU 601 drives the motor 22 to switch the door lock device 20 from the mechanical link state to the mechanical link cut state. Therefore, the door lock device 20 can be manually switched from the mechanical link cut state to the “state where the latch mechanism 50 is in the unlatched state” by the emergency unlatch operation of “performing a second operation on the inside door handle 131 after the first operation on the inside door handle 131 before the relock condition is satisfied”.

### (Switching of State by Operation on Key Cylinder)

The user of the vehicle can insert the key into the key cylinder 142 and rotate (that is, manually operate) the key to move the control lever 26 and the active lever 25 from the mechanical link position to the mechanical link cut position and from the mechanical link cut position to the mechanical link position. That is, the user can operate the key cylinder 142 to switch the door lock device 20 from the mechanical link state to the mechanical link cut state and from the mechanical link cut state to the mechanical link state.

### (Control for Preventing Opening of Door)

As described above, when the door lock device 20 is in the mechanical link cut state, by manually operating either the inside door handle 131 or the key cylinder 142, the door lock device 20 can be switched from the mechanical link cut state to the mechanical link state. A movement amount of the active lever 25 when the inside door handle 131 or the key cylinder 142 is manually operated is determined according to a movement amount (rotation angle) of the inside open lever 33 or the control lever 26. Therefore, when the operation amount of the inside door handle 131 or the operation amount of the key cylinder 142 by the user is small, the active lever 25 may not completely move from the mechanical link cut position to the mechanical link position. More precisely, the active lever 25 may not move to a position where the direction of the biasing force of the detent spring 40 changes to the mechanical link side (the predetermined intermediate point between the mechanical link cut position and the mechanical link position).

On the other hand, when the control lever 26 moves from the mechanical link cut position toward the mechanical link position, the first position switch 602 and the second position switch 603 may be switched from OFF to ON even when the active lever 25 does not reach the mechanical link position. That is, the first position switch 602 and the second position switch 603 are positioned such that the first position switch 602 and the second position switch 603 are reliably switched from OFF to ON when the control lever 26 moves to the mechanical link position, that is, the first position switch 602 and the second position switch 603 are switched from OFF to ON at a timing slightly before the control lever 26 reaches the mechanical link position (that is, at a position closer to the mechanical link cut position than to the mechanical link position). Therefore, although the active lever 25 does not reach the mechanical link position (the door lock device 20 is not switched to the mechanical link state), the door lock ECU 601 may erroneously determine that “the door lock device 20 is switched to the mechanical link state”.

When the relock condition is satisfied after the erroneous determination, in order to switch the door lock device 20 from the mechanical link state to the mechanical link cut state, the door lock ECU 601 drives the motor 22 to rotate the rotating member 23 from the neutral position toward the third rotational position. However, in this case, the door lock device 20 is actually in the mechanical link cut state and the blocking lever 38 does not move to the blocking position (located at the retracted position), and therefore, the rotating member 23 may pass through the third rotational position and reach the second rotational position. As a result, the latch mechanism 50 is switched from the latched state to the unlatched state. Accordingly, when the relock condition is satisfied during or after the inside door handle 131 or the key cylinder 142 is operated by the user and the relock operation is executed, the closed state of the door may be unintentionally released. Therefore, the door lock ECU 601 executes the following two controls in order to prevent such release of the closed state of the door which is not intended by the user.

### (1) Assist Control

When a manual operation of switching the door lock device 20 from the mechanical link cut state to the mechanical link state is detected, the door lock ECU 601 drives the motor 22 for a predetermined time to move the rotating member 23 from the neutral position to the first rotational position. Accordingly, the active lever 25 is assisted to move from the mechanical link cut position to the mechanical link position, and the active lever 25 reliably moves from the mechanical link cut position to the mechanical link position. Therefore, when the manual operation of switching the door lock device 20 from the mechanical link cut state to the mechanical link state is detected, the door lock device 20 can be reliably switched to the mechanical link state. That is, the reliability of switching the state of the door lock device 20 by the manual switching mechanism can be improved.

The method for detecting the “manual operation of switching the door lock device 20 from the mechanical link cut state to the mechanical link state” is as follows. When the inside door handle 131 is manually operated and the active lever 25 moves from the mechanical link cut position to the mechanical link position, the first position switch 602 and the second position switch 603 are switched from OFF to ON. Therefore, when the operation on the lock switch 606 is not detected but it is detected that at least one of the first position switch 602 and the second position switch 603 is switched from OFF to ON, the door lock ECU 601 determines that “the manual operation of switching the door lock device 20 from the mechanical link cut state to the mechanical link state” is performed. In addition, when the user inserts the key into the key cylinder 142 and rotates the key cylinder 142 to move the active lever 25 from the mechanical link cut position to the mechanical link position, the first key interlock switch 604 is switched from OFF to ON, and the first position switch 602 and the second position switch 603 are switched from OFF to ON. Therefore, when it is detected that the first key interlock switch 604 is switched to ON and it is detected that at least one of the first position switch 602 and the second position switch 603 is switched from OFF to ON, the door lock ECU 601 also determines that “the manual operation of switching the door lock device 20 from the mechanical link cut state to the mechanical link state” is performed.

### (2) Relock Operation Prohibition Control

Although it is determined that at least “the door lock device 20 is in the mechanical link state” (as described above, it may be determined that the door lock device 20 is in the mechanical link state even though the door lock device 20 is actually in the mechanical link cut state), the door lock ECU 601 does not execute the relock operation while the key cylinder 142 is being manually operated. That is, while the user is manually operating the key cylinder 142, the door lock device 20 may be in an intermediate state between the mechanical link cut state and the mechanical link state. Specifically, although the first position switch 602 and the second position switch 603 are ON, the blocking lever 38 may not reach the blocking position (the rotation of the rotating member 23 may not be blocked). When the rotating member 23 moves from the neutral position toward the third rotational position in this state, the rotating member 23 may reach the second rotational position without stopping at the third rotational position. Therefore, even when the relock condition is satisfied while the key cylinder 142 is being operated, the door lock ECU 601 does not execute the relock operation. When the first key interlock switch 604 or the second key interlock switch 605 is ON, the door lock ECU 601 determines that the key cylinder 142 is being manually operated.

Accordingly, according to the present embodiment, when the relock condition is satisfied in a state where a manual operation of switching the door lock device 20 from the mechanical link cut state to the mechanical link state is performed or in a state where the manual operation is being performed, the door lock device 20 is prevented from being switched to the “state where the latch mechanism 50 is in the unlatched state”. Accordingly, the vehicle door 12 can be prevented from being opened against the intention of the user.

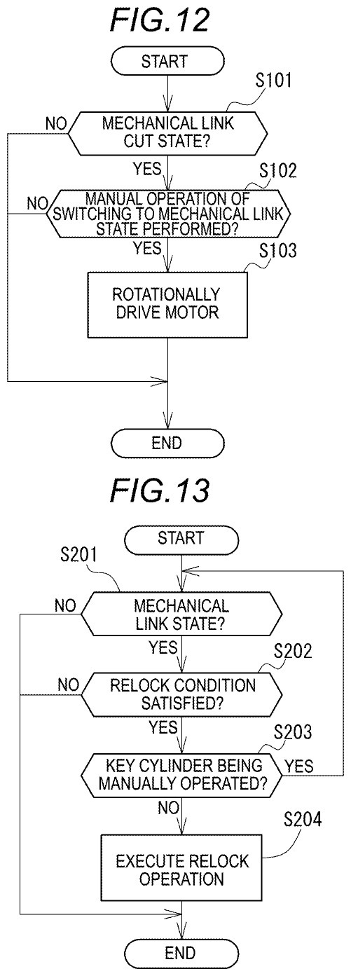

Here, a specific operation of the door lock device 20 will be described. FIG. 12 is a flowchart showing a routine to be executed by the CPU of the door lock ECU 601 to implement the above assist control. The CPU of the door lock ECU 601 repeatedly executes the routine shown in the flowchart of FIG. 12 at a predetermined cycle. Hereinafter, the CPU of the door lock ECU 601 is simply referred to as a “CPU”.

In step S101, the CPU determines whether the door lock device 20 is in the mechanical link cut state. When the state of the door lock device 20 is not the mechanical link cut state, the CPU once ends the routine. When the state of the door lock device 20 is the mechanical link cut state, the CPU proceeds to step S102.

In step S102, the CPU determines whether the manual operation of switching the state of the door lock device 20 from the mechanical link cut state to the mechanical link state is performed. When such a manual operation is not performed, the CPU once ends the routine. When such a manual operation is performed, the CPU proceeds to step S103.

In step S103, the CPU moves the rotating member 23 from the neutral position to the mechanical link cut position by rotationally driving the motor 22. Thereafter, the CPU ends the rotational driving of the motor 22.

By the CPU executing the above routine, when the manual operation of switching the door lock device 20 from the mechanical link cut state to the mechanical link state is performed, the active lever 25 is assisted by the driving force of the motor 22 to move from the mechanical link cut position to the mechanical link position. Therefore, the state of the door lock device 20 can be reliably switched from the mechanical link cut state to the mechanical link state.

FIG. 13 is a flowchart showing a routine to be executed by the CPU of the door lock ECU 601 to implement the above relock operation prohibition control. The CPU of the door lock ECU 601 repeatedly executes the routine shown in the flowchart of FIG. 13 at a predetermined cycle.

In step S201, the CPU determines whether the door lock device 20 is in the mechanical link state. When the state of the door lock device 20 is not the mechanical link state, the CPU once ends the routine. When the state of the door lock device 20 is the mechanical link state, the CPU proceeds to step S202.

In step S202, the CPU determines whether the relock condition is satisfied. When the relock condition is not satisfied, the CPU once ends the routine. When the relock condition is satisfied, the CPU proceeds to step S203.

In step S203, the CPU determines whether the key cylinder 142 is being operated based on the states of the first key interlock switch 604 and the second key interlock switch 605. When the key cylinder 142 is being operated, the CPU returns to step S201. When the key cylinder 142 is not being operated, the CPU proceeds to step S204.

In step S204, the CPU executes the relock operation. Specifically, the CPU moves the rotating member 23 from the neutral position to the mechanical link cut position by rotationally driving the motor 22. Thereafter, the CPU ends the rotational driving of the motor 22.

By the CPU executing the above routine, the execution of the relock operation can be prevented even when the relock condition is satisfied during the manual operation of the key cylinder 142. Therefore, by rotationally driving the motor 22 during the manual operation of the key cylinder 142, the door lock device 20 is prevented from being switched to a state that is not intended by the user, in particular, being switched to the “state where the latch mechanism 50 is in the unlatched state”.

Although the embodiment disclosed here has been described above, the present disclosure is not limited to the above embodiment. Various modifications can be made to the present disclosure without departing from the spirit of the present disclosure, and such modifications are also included in the technical scope of the present disclosure.

For example, the configuration of the latch mechanism 50 is not particularly limited, and a configuration well-known in the related art can be applied. In short, it is sufficient that the latch mechanism 50 is switched from the latched state to the unlatched state by moving the lift lever 52 from the initial position to the actuated position.

In addition, in the above embodiment, a configuration in which the door lock ECU 601 drives the motor 22 is shown, but the present disclosure is not limited to such a configuration. The motor 22 may also be driven by a control unit other than the door lock ECU 601, for example, a body ECU.

A vehicle door lock device (20) according to the disclosure includes: a first member (52) configured to move from an initial position to an actuated position so as to switch a latch mechanism (50), which is configured to be switched between a latched state where a vehicle door (12) is able to be held in a closed state and an unlatched state where the closed state of the vehicle door is able to be released, from the latched state to the unlatched state; a second member (30) configured to move between a mechanical link position where the second member (30) is engaged with the first member (52) so as to be able to switch the latch mechanism (50) from the latched state to the unlatched state and a mechanical link cut position where the second member (30) is not engaged with the first member (52) so as not to be able to switch the latch mechanism (50) from the latched state to the unlatched state; a third member (25) linked to the second member (30) and configured to hold the second member (30) at the mechanical link cut position by being located at a first position (a mechanical link cut position), and to hold the second member (30) at the mechanical link position by being located at a second position (a mechanical link position); a driving force source (22) configured to selectively move, by a driving force thereof, the third member (25) to either the first position (the mechanical link cut position) or the second position (the mechanical link position); an operating member (131) configured to move from an initial position to an actuated position by a manual operation of a user, and configured to, when moving from the initial position to the actuated position in a state where the third member (25) is located at the first position (the mechanical link cut position), move the third member (25) from the first position (the mechanical link cut position) to the second position (the mechanical link position); and a control unit (601) configured to drive the driving force source.

The control unit (601) is configured to, when the operating member (131) moves from the initial position to the actuated position in a state where the third member (25) is located at the first position (the mechanical link cut position), drive the driving force source (22) to move the third member (25) from the first position (the mechanical link cut position) to the second position (the mechanical link position).

According to the disclosure, when the operating member (131) is manually operated to move the third member (25) from the first position to the second position, the control unit (601) drives the driving force source (22) to move the third member (25) from the first position (the mechanical link cut position) to the second position (the mechanical link position). With such a configuration, even when the third member (25) does not move from the first position to the second position by the manual operation due to an insufficient operation amount of the manual operation on the operating member (131), the third member (25) moves from the first position to the second position by the driving force of the driving force source (22). Therefore, the door lock device (20) can be reliably switched from a mechanical link cut state (a state where the second member (30) is located at the mechanical link cut position) to a mechanical link state (a state where the second member (30) is located at the mechanical link position).

According to an aspect of the disclosure, the control unit (601) may be configured to: determine whether the third member (25) moves from the first position (the mechanical link cut position) to the second position (the mechanical link position) by a manual operation on the operating member (131), when it is determined that the third member (25) moves from the first position (the mechanical link cut position) to the second position (the mechanical link position) by the manual operation on the operating member (131), then determine whether a relock condition, which is a condition for moving the third member (25) from the second position (the mechanical link position) to the first position (the mechanical link cut position), is satisfied, and when it is determined that the relock condition is satisfied, drive the driving force source (22) to move the third member (25) from the second position (the mechanical link position) to the first position (the mechanical link cut position).

With such a configuration, when the relock condition is satisfied in a case where the door lock device (20) is in the mechanical link state (the state where the second member (30) is located at the mechanical link position), the control unit (601) executes a relock operation, which is an operation of moving the third member (25) from the second position (the mechanical link position) to the first position (the mechanical link cut position). Accordingly, the door lock device (20) is maintained in a state where the vehicle door (12) cannot be opened by a normal door opening operation on the operating member (131) (specifically, an operation of moving the operating member (131) from the initial position to the actuated position once).

When the relock condition is satisfied and the control unit (601) drives the driving force source (22), the door lock device (20) is prevented from being switched to a state not intended by the user. That is, although the third member (25) does not move from the first position (the mechanical link cut position) to the second position (the mechanical link position) due to the insufficient operation amount of the manual operation on the operating member (131), the control unit (601) may erroneously determine that the third member (25) moves from the first position (the mechanical link cut position) to the second position (the mechanical link position). When the relock condition is satisfied after the erroneous determination, although the third member (25) is not located at the second position (the mechanical link position), the control unit (601) drives the driving force source (22) to move the third member (25) from the second position (the mechanical link position) to the first position (the mechanical link cut position). That is, although the third member (25) is not located at the second position (the mechanical link position), the control is executed on the assumption that the third member (25) is located at the second position (the mechanical link position). As a result, the door lock device (20) may be switched to a state not intended by the user (an unexpected state). However, according to the above configuration, when the operating member (131) is manually operated, the third member (25) reliably moves from the first position (the mechanical link cut position) to the second position (the mechanical link position) by the driving force of the driving force source (22). Therefore, after the relock condition is satisfied, the third member (25) can be reliably moved from the second position (the mechanical link position) to the first position (the mechanical link cut position). That is, the door lock device (20) can be prevented from being switched to a state not intended by the user.

Further, a vehicle door lock device (20) according to the disclosure includes: a first member (52) configured to move from an initial position to an actuated position so as to switch a latch mechanism (50), which is configured to be switched between a latched state where a vehicle door (12) is able to be held in a closed state and an unlatched state where the closed state of the vehicle door is able to be released, from the latched state to the unlatched state; a second member (30) configured to move between a mechanical link position where the second member (30) is engaged with the first member (52) so as to be able to switch the latch mechanism (50) from the latched state to the unlatched state and a mechanical link cut position where the second member (30) is not engaged with the first member (52) so as not to be able to switch the latch mechanism (50) from the latched state to the unlatched state; a third member (25) linked to the second member (30) and configured to hold the second member (30) at the mechanical link cut position by being located at a first position (a mechanical link cut position), and to hold the second member (30) at the mechanical link position by being located at a second position (a mechanical link position); a driving force source (22) configured to selectively move, by a driving force thereof, the third member (25) to either the first position (the mechanical link cut position) or the second position (the mechanical link position); a key cylinder (142) configured to allow a rotation operation by inserting a key from a vehicle outer side, and configured to move the third member (an active lever) located at the second position (the mechanical link position) to the first position (the mechanical link cut position) by the rotation operation in a predetermined direction and move the third member (the active lever) located at the first position (the mechanical link cut position) to the second position (the mechanical link position) by the rotation operation in a direction opposite to the predetermined direction; and a control unit (601) configured to drive the driving force source (22).

The control unit (601) is configured to: determine, when the third member (25) is located at the second position (the mechanical link position), whether a relock condition, which is a condition for moving the third member (25) from the second position to the first position (the mechanical link cut position), is satisfied and whether the key cylinder (142) is being operated, when it is determined that the relock condition is satisfied and that the key cylinder (142) is not being operated, drive the driving force source (22) to move the third member (25) to the first position (the mechanical link cut position), and when it is determined that the relock condition is satisfied and that the key cylinder (142) is being operated, not drive the driving force source (22).

According to the disclosure, the door lock device (20) is prevented from being switched to a state not intended by the user. That is, when the key cylinder (142) is being operated, the third member (25) may be located between the first position (the mechanical link cut position) and the second position (the mechanical link position). In this state, when the relock condition is satisfied and the driving force source (22) is driven, the state of the door lock device (20) may be switched to a state not intended by the user. Therefore, when the relock condition is satisfied and the key cylinder (142) is being operated, the control unit (601) does not execute the operation of moving the third member (25) to the first position (the mechanical link cut position). Accordingly, the door lock device (20) can be prevented from being switched to a state not intended by the user.

According to an aspect of the disclosure, the door lock device (20) may further include: a rotating member (23) interposed between the driving force source (22) and the third member (25) and configured to rotate between a first rotational position and a second rotational position by a driving force of the driving force source (22); a first biasing member (24) configured to elastically bias the rotating member (23) to a neutral position between the first rotational position and the second rotational position; a fourth member (29) configured to move between an initial position and an actuated position and configured to, by moving from the initial position to the actuated position, move the first member (52) from the initial position to the actuated position without using the second member (30); a blocking member (38) configured to move between a retracted position deviated from a rotation trajectory of the rotating member (23) and a blocking position within the rotation trajectory of the rotating member (23); and a second biasing member (39) configured to elastically bias the blocking member (38) toward the retracted position.

When being located at the first position (the mechanical link cut position), the third member (25) is engaged with the rotating member (23) so as to move from the first position (the mechanical link cut position) toward the second position (the mechanical link position) when the rotating member (23) rotates from the neutral position to the first rotational position, and when being located at the second position (the mechanical link position), the third member (25) is engaged with the rotating member (23) so as to move from the second position (the mechanical link position) toward the first position (the mechanical link cut position) when the rotating member (23) rotates from the neutral position to a third rotational position between the neutral position and the second rotational position. The fourth member (29) is engaged with the rotating member (23) at the second rotational position when the rotating member (23) rotates from the neutral position to the second rotational position, so as to rotate from the initial position to the actuated position. The blocking member (38) is engaged with the third member (25) so as to move, when the third member (25) moves from the first position (the mechanical link cut position) to the second position (the mechanical link position), from the retracted position to the blocking position against an elastic biasing force of the second biasing member (39). The rotating member (23) is engaged with the blocking member (38) at the third rotational position when rotating in a direction from the neutral position toward the third rotational position when the third member (25) is located at the second position (the mechanical link position), and rotation of the rotating member (23) in a direction from the third rotational position toward the second rotational position is blocked.

With such a configuration, when the third member (25) is located at the second position (the mechanical link position), the blocking member is located at the blocking position against the elastic biasing force of the second biasing member (39). At this time, when the rotating member (23) is moved from the neutral position to the third rotational position, the third member (25) moves from the second position (the mechanical link position) toward the first position (the mechanical link cut position). On the other hand, the blocking member (38) is engaged with the rotating member at the third rotational position to be held at the blocking position. Therefore, the rotating member (23) at the third rotational position is engaged with the blocking member (38), so that the rotating member (23) is prevented from passing through the third rotational position and moving to the second rotational position.

That is, the following effect can be exerted when a relock operation (an operation of moving the rotating member (23) from the neutral position to the third rotational position by the driving force of the driving force source (22)), which is an operation of moving the third member (25) from the second position (the mechanical link position) to the first position (the mechanical link cut position), is executed in a case where the relock condition is satisfied. When a manual operation of switching the door lock device (20) from the mechanical link cut state to the mechanical link state is performed on the operating member (131), the third member (25) reliably moves to the second position by the driving force of the driving force source (22), and accordingly, the blocking member (38) moves to the blocking position. Therefore, when the relock operation is performed, the rotating member (23) can be reliably stopped at the third rotational position by the blocking member (38) (the rotating member (23) can be prevented from passing through the third rotational position and reaching the second rotational position). Therefore, the door lock device (20) is prevented from being switched to a state not intended by the user (a state where the vehicle door can be opened).

Further, the following effect can be exerted when the driving force source (22) is not driven even when the relock condition is satisfied while the key cylinder (142) is being operated. When the third member (25) moves to the first position by the operation of the key cylinder (142), the blocking member (38) moves from the blocking position to the retracted position. Then, when the blocking member (38) is located at the retracted position, the rotating member (23) can move from the neutral position to the second rotational position exceeding the third rotational position. Therefore, when the relock operation (the operation of moving the rotating member (23) from the neutral position to the third rotational position by the driving force of the driving force source (22)) is executed in this state, the rotating member (23) moves to the second rotational position without stopping at the third rotational position, and as a result, the latch mechanism (50) may be switched to the unlatched state. However, since the driving force source (22) is not driven (the relock operation is not executed) even when the relock condition is satisfied while the key cylinder (142) is being operated, the latch mechanism (50) can be prevented from being switched to the unlatched state while the key cylinder (142) is being operated.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle door lock device comprising:
a first member configured to move from an initial position to an actuated position so as to switch a latch mechanism, which is configured to be switched between a latched state where a vehicle door is able to be held in a closed state and an unlatched state where the closed state of the vehicle door is able to be released, from the latched state to the unlatched state;
a second member configured to move between a mechanical link position where the second member is engaged with the first member so as to be able to switch the latch mechanism from the latched state to the unlatched state and a mechanical link cut position where the second member is not engaged with the first member so as not to be able to switch the latch mechanism from the latched state to the unlatched state;
a third member linked to the second member and configured to hold the second member at the mechanical link cut position by being located at a first position and to hold the second member at the mechanical link position by being located at a second position;
a driving force source configured to selectively move, by a driving force thereof, the third member to either the first position or the second position;
an operating member configured to move from an initial position to an actuated position by a manual operation of a user, and configured to, when moving from the initial position to the actuated position in a state where the third member is located at the first position, move the third member from the first position to the second position; and
a control unit configured to drive the driving force source, wherein
the control unit is configured to, when the operating member moves from the initial position to the actuated position in a state where the third member is located at the first position, drive the driving force source to move the third member from the first position to the second position.

2. The vehicle door lock device according to claim 1, wherein
the control unit is configured to:
determine whether the third member moves from the first position to the second position by a manual operation on the operating member,
when it is determined that the third member moves from the first position to the second position by the manual operation on the operating member, then determine whether a relock condition, which is a condition for moving the third member from the second position to the first position, is satisfied, and
when it is determined that the relock condition is satisfied, drive the driving force source to move the third member from the second position to the first position.

3. A vehicle door lock device comprising:
a first member configured to move from an initial position to an actuated position so as to switch a latch mechanism, which is configured to be switched between a latched state where a vehicle door is able to be held in a closed state and an unlatched state where the closed state of the vehicle door is able to be released, to the unlatched state;
a second member configured to move between a mechanical link position where the second member is engaged with the first member so as to be able to switch the latch mechanism to the unlatched state and a mechanical link cut position where the second member is not engaged with the first member so as not to be able to switch the latch mechanism to the unlatched state;
a third member linked to the second member and configured to hold the second member at the mechanical link cut position by being located at a first position and to hold the second member at the mechanical link position by being located at a second position;
a driving force source configured to selectively move, by a driving force thereof, the third member to either the first position or the second position;
a key cylinder configured to allow a rotation operation by inserting a key from a vehicle outer side, and configured to move the third member located at the second position to the first position by the rotation operation in a predetermined direction and move the third member located at the first position to the second position by the rotation operation in a direction opposite to the predetermined direction; and
a control unit configured to drive the driving force source, wherein
the control unit is configured to:
determine, when the third member is located at the second position, whether a relock condition, which is a condition for moving the third member from the second position to the first position, is satisfied and whether the key cylinder is being operated,
when it is determined that the relock condition is satisfied and that the key cylinder is not being operated, drive the driving force source to move the third member to the first position, and
when it is determined that the relock condition is satisfied and that the key cylinder is being operated, not drive the driving force source.

4. The vehicle door lock device according to claim 1, further comprising:
a rotating member interposed between the driving force source and the third member and configured to rotate between a first rotational position and a second rotational position by the driving force of the driving force source;
a first biasing member configured to elastically bias the rotating member to a neutral position between the first rotational position and the second rotational position;
a fourth member configured to move between an initial position and an actuated position and configured to, by moving from the initial position to the actuated position, move the first member from the initial position to the actuated position without using the second member;
a blocking member configured to move between a retracted position deviated from a rotation trajectory of the rotating member and a blocking position within the rotation trajectory of the rotating member; and
a second biasing member configured to elastically bias the blocking member toward the retracted position, wherein
when being located at the first position, the third member is engaged with the rotating member so as to move from the first position toward the second position when the rotating member rotates from the neutral position to the first rotational position, and when being located at the second position, the third member is engaged with the rotating member so as to move from the second position toward the first position when the rotating member rotates from the neutral position to a third rotational position between the neutral position and the second rotational position,
the fourth member is engaged with the rotating member at the second rotational position when the rotating member rotates from the neutral position to the second rotational position, so as to rotate from the initial position to the actuated position,
the blocking member is engaged with the third member so as to move, when the third member moves from the first position to the second position, from the retracted position to the blocking position against an elastic biasing force of the second biasing member, and
the rotating member is engaged with the blocking member at the third rotational position when rotating in a direction from the neutral position toward the third rotational position when the third member is located at the second position, and rotation of the rotating member in a direction from the third rotational position toward the second rotational position is blocked.
